(19) United States
(12) Patent Application Publication
(10) Pub. No.: US 2025/0094214 A1
(43) Pub. Date: Mar. 20, 2025

(54) METHODS FOR ADJUSTING A PRIORITY OF SUBMISSION QUEUES, HOSTS, ELECTRONIC DEVICES, AND COMPUTER DEVICES

(71) Applicant: Yangtze Memory Technologies Co., Ltd., Wuhan (CN)

(72) Inventor: Tianyi Wang, Wuhan (CN)

(21) Appl. No.: 18/424,370

(22) Filed: Jan. 26, 2024

(30) Foreign Application Priority Data
Sep. 18, 2023 (CN) 202311212429.2

(51) Int. Cl. G06F 9/48

(52) U.S. Cl. CPC G06F 9/4881

(57) ABSTRACT

The present disclosure provides a method for adjusting a priority of a submission queue. The method includes: acquiring latency periods of a plurality of submission queues, wherein the latency periods of the submission queues are determined by an average value of completion periods of a plurality of commands in the submission queues, and the completion period is a difference between a timing at which an execution of the command is completed and a timing at which the command is added to the submission queue; determining latency scores of the submission queues based on the latency periods of the submission queues; determining a target submission queue among the plurality of submission queues based on the latency scores of the submission queues and adjusting the priority of the target submission queue; and sending an instruction to give notification of a result of a priority adjustment of the target submission queue.

### CROSS REFERENCE TO RELATED APPLICATIONS

This application claims priority to and the benefit of Chinese Patent Application 202311212429.2, filed on Sep. 18, 2023, which is hereby incorporated by reference in its entirety.

### TECHNICAL FIELD

The present disclosure relates to the field of data storage technology, and relates particularly to a method for adjusting a priority of a submission queue, a host, an electronic device, and a computer device.

### BACKGROUND

Non-volatile memory express (NVMe) is a communication protocol and interface standard for connecting a host (e.g., a computer) with a non-volatile memory device (e.g., a solid-state drive) and is intended to optimize read/write performance of the non-volatile memory device and thus achieve a higher data transmission rate and a lower access latency.

### BRIEF DESCRIPTION OF DRAWINGS

In order to explain technical solutions of the present disclosure more clearly, accompanying drawings required by implementations of the present disclosure will be described briefly hereafter. It is obvious that the drawings to be described below are only for some implementations of the present disclosure and other drawings can be obtained according to those drawings by those skilled in the art. Moreover, the accompanying drawings to be described below may be considered as schematic diagrams and are not intended to limit actual sizes of a product, an actual flow of a method, and actual timing of signals involved in implementations of the present disclosure.

FIG. 1 is a schematic diagram illustrating a round robin arbitration mechanism provided in an implementation of the present disclosure;

FIG. 2 is a schematic diagram illustrating a weighed round robin arbitration mechanism with an urgent priority provided in an implementation of the present disclosure;

FIG. 3 is a structural schematic diagram of an electronic device provided in an implementation of the present disclosure;

FIG. 4 is a structural schematic diagram of an NAND flash memory provided in an implementation of the present disclosure;

FIG. 5 is a schematic flow chart of a method of adjusting a priority of a submission queue provided in an implementation of the present disclosure;

FIG. 6 is a schematic flow chart of an exemplary process of operation S2 provided in an implementation of the present disclosure;

FIG. 7 is a schematic flow chart of an exemplary process of operation S3 provided in an implementation of the present disclosure; and

FIG. 8 is a schematic flow chart of another exemplary process of operation S2 provided in an implementation of the present disclosure.

Reference Numerals: 100: electronic device, 110: host, 111: host processor, 112: host memory, 113: bus, 114: first interface, 120: memory system, 121: memory controller, 122: memory, 123: second interface, 210: die, 220: plane, 230: block, and 240: page.

### DETAILED DESCRIPTION

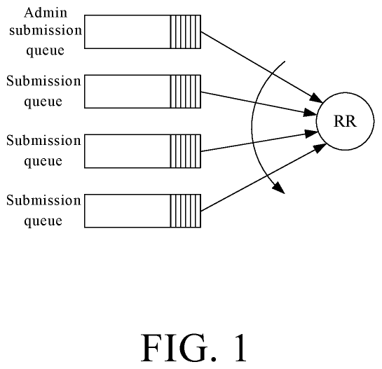

Technical solutions in some implementations of the present disclosure will be described below clearly and completely in connection with FIGS. 1 to 8. It is obvious that the implementations to be described are only some, not all, implementations of the present disclosure. All other implementations obtained by those skilled in the art based on the implementations provided in the present disclosure fall within the scope claimed by the present disclosure.

In the whole specification and claims, the term “include” or “comprise” should be interpreted to be open and inclusive, i.e. to have the meaning of “include or comprise, but not limited to”, unless indicated otherwise in the context. In the description of the specification, terms such as “one implementation”, “some implementations”, “example implementations”, “illustratively” or “some examples” are intended to mean that specific features, structures, materials or characteristics related to the implementation(s) or example(s) are included in at least one implementation or example of the present disclosure. Reference to the above-mentioned terms may not necessarily refer to one and the same implementation or example. Moreover, the specific features, structures, materials or characteristics may be included in any one or more implementations or examples in any suitable way.

Hereafter, the terms “first”, “second”, etc. are only used for the purpose of description and should not be understood to indicate or imply relative importance or to specify the number of the referenced technical features implicitly. Therefore, a feature as defined by “first” or “second” may indicate explicitly or implicitly that one or more instances of the feature are included. In description of implementations of the present disclosure, the expression “a plurality of” means two or more unless otherwise specified.

In description of some implementations, the term “couple” and its derivative expressions may be used. For example, in description of some implementations, the term “couple” may be used to indicate that two or more components are in direct physical or electrical contact with each other. In this case, the term “couple” can also be substituted by the term “connect”. Furthermore, the term “couple” may also indicate that two or more components are not in direction contact with each other, but still cooperate or interact with each other. Implementations of the present disclosure are not necessarily limited by what is described herein.

The use of “configured to” herein has an open and inclusive meaning and is not intended to exclude that a device is suitable for additional tasks or operations or configured to perform additional tasks or operations.

Currently, protocol specifications for data transmission between a memory system and a host mainly include an advanced host controller interface (AHCI) specification and a non-volatile memory express (NVMe) specification. The AHCI herein is in a single queue mode; that is, data interaction between the host and the memory system is done with one queue. Hard disk drive (HDD) and solid state drive (SSD) at an early phase generally use the AHCI protocol.

Different from the characteristic of sequential reading/writing for HDD, data can be read by SSD from multiple different locations simultaneously with high concurrency, and as a result, the single queue mode of the AHCI protocol becomes a bottleneck to constrain the concurrency of the SSD. Compared with the AHCI protocol, the NVMe protocol supports a plurality of queues (65536 queues at most), so that the advantage of concurrent storage for SSD can be fully leveraged to dramatically improve the read/write performance of SSD. In the NVMe protocol, the host may put the admin commands mainly for administration of the memory system into an admin submission queue (ASQ) and put the NVM commands mainly for data transmission into a submission queue (SQ). Illustratively, the host may put commands into a submission queue and then use a doorbell register to notify the memory system to fetch the commands from the submission queue. After execution of the commands is completed by the memory system, the execution results are written into a completion queue (CQ) corresponding to the submission queue, which causes an interruption to notify the host that the commands have been executed. The host checks the execution results in the completion queue and then notifies the memory system that the execution results in the completion queue have been checked, so that the execution of the commands is completed.

The memory system needs a rule to determine the fetching order of the commands in an admin submission queue and a plurality of submission queues and the rule is referred to as a multi-queue arbitration mechanism. Currently, the NVMe protocol mainly defines two arbitration mechanisms, in which one is a round robin arbitration (RR), and the other is a weighted round robin arbitration (WRR) with an urgent priority.

The RR mechanism is as shown in FIG. 1. The arbitration mechanism makes a round robin of an admin submission queue and a plurality of submission queues, and fetches and executes a certain number of commands from each submission queue sequentially, the admin submission queue having the same priority as the plurality of submission queues.

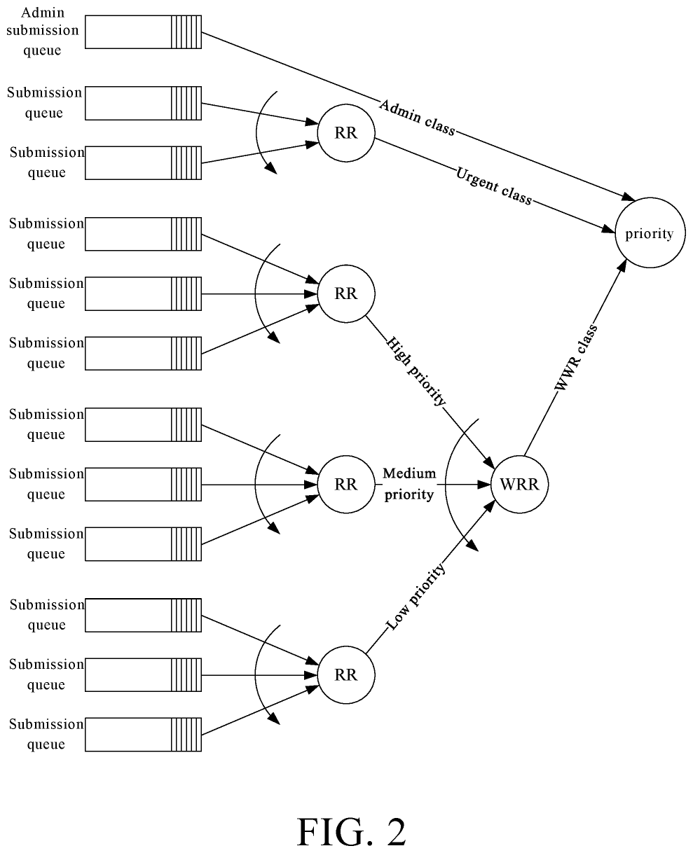

The WRR mechanism with an urgent priority is as shown in FIG. 2. Illustratively, the WRR mechanism with an urgent priority defines three strict priorities. These three strict priorities are an admin class, an urgent class and a WWR class respectively. The admin class is higher than the urgent class, which is higher than the WWR class. That is, the memory system always fetches and executes a command from an admin submission queue first, and then fetches and executes a command from a submission queue having the urgent class and then fetches and executes a command from a submission queue having the WWR class. In some implementations, the admin submission queue always has the admin class with the highest strict priority, and the host only needs to configure the strict priorities of the submission queues. Illustratively, the host may configure a submission queue with a strict priority of the urgent class or WWR class. The round robin mechanism is used among the admin submission queues and among the submission queues with the same strict priority.

The WWR class of the lowest strict priority includes a high priority, a medium priority and a low priority. The weighed round robin arbitration mechanism is used among submission queues with the three priorities. The host may configure weights of these three priorities, representing the number of commands fetched from a submission queue each time.

In some implementations, the round robin arbitration mechanism reads commands from respective submission queues sequentially without using priorities, and all the submission queues are scheduled with the same probability. As a result, critical services sensitive to a delay and non-critical services can't be distinguished from each other, which may result in that the critical services can't be performed in time. The weighed round robin arbitration with an urgent priority can ensure commands in a submission queue with a high priority to be fully scheduled, but since there is no fair agreement between priorities, commands in a submission queue with a low priority (e.g., the low priority of the WWR class) may also wait for a long time to be executed, which may negatively affect execution of and response to commands. When the waiting time reach a certain value, there will be no practical significance in spite of completion of execution of commands.

In an implementation of the present disclosure, the latency period of a submission queue is calculated regularly by using a difference between a timing at which an execution of each of a plurality of commands in the submission queue is completed and a timing at which each of the commands is added to the submission queue. The longer the latency period of the submission queue is, the higher the risk that the commands in the submission queue remains unexecuted for a long time is, and as a result the easier the timeout of the commands or any other downtime risk is to occur. Therefore, in the present disclosure, the submission queue with a relatively larger latency period may be considered as a more urgent submission queue, and the host adjusts the priority of the submission queue and notifies the memory system so as to reduce the risk that commands in the submission queue remains unexecuted for a long time.

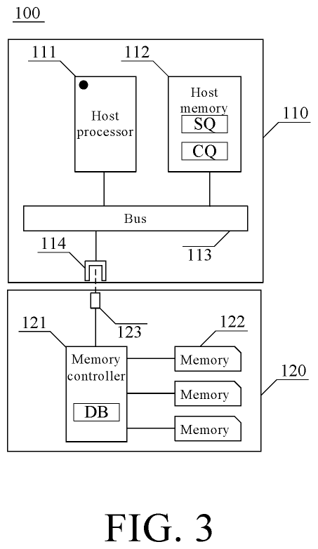

As shown in FIG. 3, an implementation of the present disclosure provides an electronic device 100 including a host 110 and a memory system 120. The electronic device 100 may be a terminal device, such as a cellphone, a television set, a display and a tablet computer, or may be a wearable smart device such as a smart watch, a smart bracelet and virtual reality (VR) glasses, or may be a communication device such as a server and a base station, or may be a control device such as a vehicle-mounted computer. In implementations of the present disclosure, the specific form of the electronic device 100 is not limited specially.

In an example, the above-described host 110 may include a host processor 111, a host memory 112, a bus 113 and an interface circuit. The host processor 111, the interface circuit and the host memory 112 are coupled with each other through the bus 113. The interface circuit includes a first interface 114. The above-described memory system 120 may be an NVMe SSD and may include a memory controller 121, a memory 122 and a second interface 123. The host 110 and the memory system 120 are coupled with each other through the first interface 114 and the second interface 123.

The above-described host processor 111 or the memory controller 121 may be a chip. For example, the chip may be a field programmable gate array (FPGA), an application specific integrated circuit (ASIC), a system on chip (SoC), a central processor unit (CPU), a digital signal processor (DSP), a micro controller unit (MCU), a programmable logic device (PLD) or any other integrated chip.

The host memory 112 may be a non-volatile storage medium, for example, a random access memory (RAM), which can take various forms, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM) and a direct rambus RAM (DR RAM), and is not limited in the present disclosure.

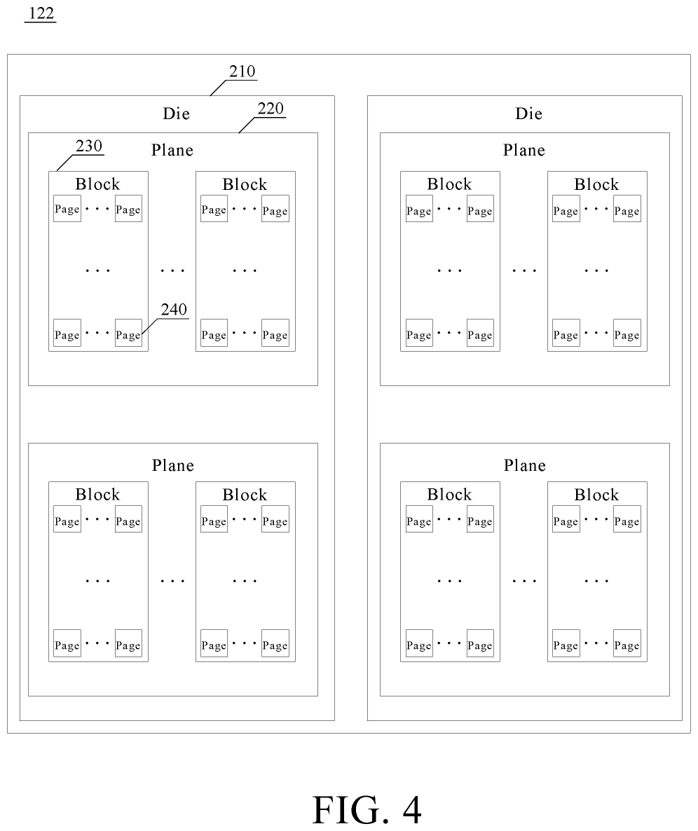

The memory 122 may be a flash memory (e.g., an NAND flash memory or an NOR flash memory), which doesn't have mechanical components for a traditional hard disk drive such as a magnetic head, a disk shaft and a motor, and doesn't involve a rotating process of the motor, and thus is free of mechanical failures and has no concern about impact, shock and vibration. Therefore, the flash memory has absolute advantages over the hard disk drive in performance, reliability, energy consumption and portability, and is applied widely to the fields of civil use, vehicles, industrial control, electric power, medical care, aviation, navigation apparatus and the like. The present disclosure takes an NAND flash memory as an example of the memory 122, but is not limited thereto. As this point, the memory controller 121 may control the memory 122 through an open NAND flash interface (ONFI) or a toggle interface. FIG. 4 shows a structure of an NAND flash memory including a plurality of dies 210. Each die 210 includes a plurality of planes 220. Each plane 220 includes a plurality of blocks 230. Each block includes a plurality of pages.

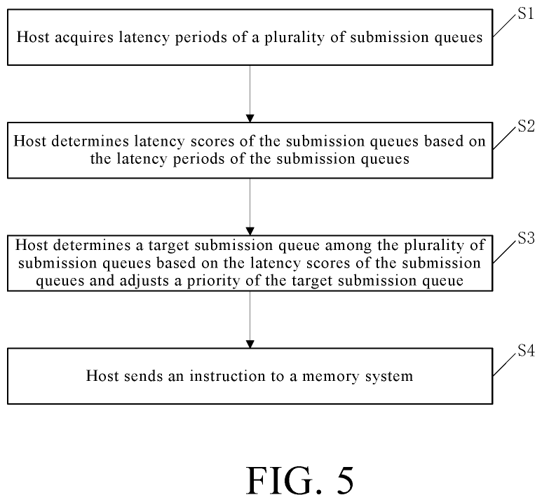

In an example, the host processor 111 of the above-described host 110 may perform a method of adjusting a priority of a submission queue. As shown in FIG. 5, the method includes the following operations S1 to S4.

In operation S1, the host acquires latency periods of a plurality of submission queues.

That is, the host 110 acquires the latency period of each of the plurality of submission queues. The host 110 may acquire latency periods of a plurality of submission queues according to a preset time rule, for example, once every ten minutes. As shown in FIG. 3, a plurality of submission queues and corresponding completion queues are established in a memory (e.g., the host memory 112) shared by the host 110 and the memory system 120, and a doorbell register is located in the controller at the side of the memory system 120. The latency period of each submission queue is determined by an average value of completion periods of a plurality of commands in the submission queue. As described above, the host 110 may put one or more ready commands into a submission queue and then use the doorbell register to notify the memory system 120 to fetch a command from the submission queue into a controller buffer. The memory system 120 may fetch and execute one or more commands and write the execution result(s) of the command(s) into the corresponding completion queue regardless the success or failure of the execution of the command(s), and trigger an interruption to notify the host 110 of completion of the command(s). The host 110 checks the execution result(s) in the completion queue and then notifies the memory system that the execution result(s) in the completion queue has been checked. Then, the execution of the command(s) is completed. It can be understood that the completion period of one command is equal to the difference between a timing at which the execution of the command is completed and a timing at which the command is added to the submission queue. In implementations of the present disclosure, the latency period of each submission queue may be equal to the average value of a sum of the completion periods of a plurality of commands in the submission queue.

In operation S2, the host determines latency scores of the submission queues based on the latency periods of the submission queues.

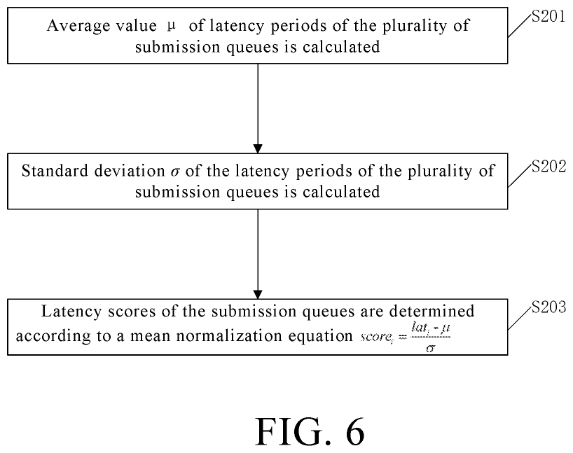

That is, the host 110 determines the latency score of each submission queue based upon the latency period of each submission queue. As shown in FIG. 6, operation S2 may include the following sub-operations S201 to S203.

In sub-operation S201, an average value μ of latency periods of a plurality of submission queues is calculated.

In some implementations, the average value μ of latency periods of the plurality of submission queues may be calculated by the equation

$$μ = \frac{{\sum }_{i = 0}^{i = n} {lat}_{i}}{n} ,$$

wherein n is the number of the submission queues, and latᵢ is the latency period of the ith submission queue of n submission queues; that is, μ is the average value of a sum of completion periods of a plurality of commands in the submission queue.

In sub-operation S202, a standard deviation σ of the latency periods of the plurality of submission queues is calculated.

In an example, the standard deviation σ of latency periods of a plurality of submission queues may be calculated by the equation

$$σ = \sqrt{\frac{{\sum }_{i = 0}^{i = n} {( {lat}_{i} - μ )}^{2}}{n - 1}} .$$

In sub-operation S203, latency scores of the submission queues are determined according to the mean normalization (also referred to as a z-score normalization) equation

$${score}_{i} = \frac{{lat}_{i} - μ}{σ} ,$$

wherein scoreᵢ is the latency score of the ith submission queue in n submission queues. It should be understood that the latency scores can also calculated by using any other processing method of data standardization including, but not limited to, a linear normalization (also referred to as a min-max normalization), which will not be described in more detail.

In operation S3, the host determines a target submission queue among the plurality of submission queues based on the latency scores of the submission queues and adjusts a priority of the target submission queue.

In an example, the higher the latency score of a submission queue is, the longer the time, for which the commands in the submission queue wait to be executed, is, i.e. the higher the risk that the commands in the submission queue aren't executed for a long time is. Therefore, among a plurality of submission queues, a submission queue with the highest latency score is determined as a first target submission queue and the priority of the first target submission queue is adjusted to be the urgent class, so that the commands in the first target submission queue can be processed with priority; and/or among the plurality of submission queues, a submission queue with the lowest latency score is determined as a second target submission queue and the priority of the second target submission queue is adjusted to be the WWR class. For example, the priority of the second target submission queue may be adjusted to be the high priority of the WWR class, so as to avoid the round robin of a plurality of submission queues having the urgent class, which results in that the commands in the first target submission queue aren't executed in time. Thereby, the risk that commands aren't executed for a longer time may be reduced.

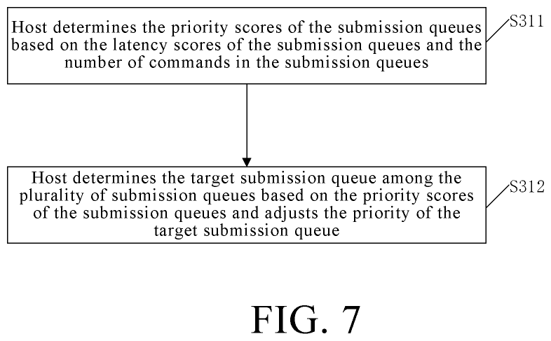

In some implementations, for a submission queue with a relatively low priority and having a relatively large number of commands, the commands at relatively rear location in the submission queue also have the risk of remaining unexecuted for a long time. Therefore, as shown in FIG. 7, operation S3 may include the following sub-operations S311 to S312.

In sub-operation S311, the host determines priority scores of the submission queues based on the latency scores of the submission queues and a number of commands in the submission queues.

In an example, the priority score priorityᵢ of the ith submission queue of n submission queues may be determined by the product of the latency score scoreᵢ of the submission queue and the number cmd_numᵢ of commands in the submission queue. In an implementation of the present disclosure, the priority score priorityᵢ of the ith submission queue of the n submission queues may be calculated by the equation priorityᵢ=scoreᵢ×cmd_numᵢ.

In sub-operation S312, the host determines the target submission queue among the plurality of submission queues based on the priority scores of the submission queues and adjusts the priority of the target submission queue.

In an example, among the plurality of submission queues, the submission queue with the highest priority score is determined as the first target submission queue and the priority of the first target submission queue is adjusted to be the urgent class; and/or among the plurality of submission queues, the submission queue with the lowest priority score is determined as the second target submission queue and the priority of the second target submission queue is adjusted to be the WWR class.

For a submission queue having a relatively larger number of commands therein, the commands at relatively rear location in the submission queue may also have the risk of remaining unexecuted for a long time. Compared with the method shown in FIG. 6, the method provided in FIG. 7 determines priority scores of submission queues from the number of commands in the submission queues and the latency scores of the submission queues, and determines and adjusts the priority of the target submission queue from the priority scores of the submission queues. Thereby, the commands at relatively rear location in a submission queue having a relatively larger number of commands may have a reduced risk of remaining unexecuted for a long time.

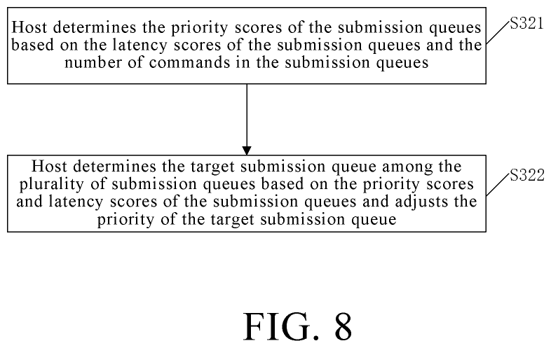

As shown in FIG. 8, in some implementations, operation S3 may also include sub-operations S321 to S322. The sub-operation S321 is the same as the sub-operation S311 and will not be repeated here.

In sub-operation S322, the host determines the target submission queue among the plurality of submission queues based on the priority scores and latency scores of the submission queues and adjusts the priority of the target submission queue.

In an example, among the submission queues with latency scores higher than a first threshold, the submission queue with the highest priority score is determined as the first target submission queue and the priority of the first target submission queue is adjusted to be the urgent class; and/or among the plurality of submission queues with latency scores lower than a second threshold, the submission queue with the lowest priority score is determined as the second target submission queue and the priority of the second target submission queue is adjusted to be the WWR class. The second threshold is lower than the first threshold.

The first threshold and the second threshold here may be set according to historical experiences. Illustratively, the priority of the submission queue with a latency score higher than or equal to 3 (scoreᵢ≥3) and having the highest priority score is adjusted to be the urgent class. Likewise, the priority of the submission queue with a latency score lower than or equal to −3 (scoreᵢ≤−3) and having the lowest priority score is adjusted to be the WWR class.

For a submission queue having too many commands therein but having a relatively low latency score, a single command in the submission queue needs a short time to be executed, so that commands in the submission queue can be executed at a relatively fast speed even though too many commands are put into the submission queue. However, if a too large number of commands are put into a submission queue so that the submission queue has a relatively large priority score, then the priority adjustment of submission queues using only priority scores of submission queues may cause an incorrect priority adjustment. Therefore, as compared with the method shown in FIG. 7, the method provided in FIG. 8 adjusts a priority of a submission queue using the priority score and the latency score of the submission queue in combination, so that the situation that the priority adjustment is incorrect due to a too large number of the commands in the submission queue resulting in a relatively higher priority score can be avoided to some extent.

It should be understood that, if the priority of the first target submission queue as determined by the host 110 is the urgent class, then it can be said that the host 110 maintains the priority of the first target submission queue as the urgent class. That is to say, if the priority of the first target submission queue as determined by the host 110 is the urgent class, then the host 110 will not adjust the priority of the first target submission queue. Likewise, if the priority of the second target submission queue as determined by the host 110 is the WWR class, then it can be said that the host 110 maintains the priority of the second target submission queue as the WWR class. For example, if the priority of the second target submission queue is the high priority of the WWR class, then the host 110 maintains the priority of the second target submission queue as the high priority of the WWR class. That is to say, if the priority of the second target submission queue as determined by the host 110 is the urgent class, then the host 110 will not adjust the priority of the second target submission queue.

In operation S4, the host sends an instruction to the memory system.

In an example, a host processor 111 of a host 110 controls a first interface 114 to send a first instruction to a second interface 123 of a memory system 120. The first instruction is configured to notify the memory system 120 of a priority adjustment result of the target submission queue in the plurality of submission queues. After receiving the first instruction through the second interface 123, the memory system 120 sends a second instruction to the first interface 114 of the host 110 through the second interface 123. The second instruction is configured to provide a feedback to the host 110 to indicate that the memory system 120 has received the first instruction.

After the priority adjustment of the submission queues is completed by the host 110, the memory system 120 fetches and executes commands from a plurality of submission queues through the second interface 123 according to the adjusted priorities and based on the weighed round robin arbitration mechanism with the urgent class. After completing the execution of the commands, the memory system 120 may also write the execution results to the completion queue through the second interface 123 and notify the host 110 of the completion of command execution. Through the second interface 123, the memory system 120 may also receive the notification that the execution results in the completion queue have been checked by the host 110.

The present disclosure further provides a computer readable storage medium having computer executable instructions stored thereon, which, when executed, can implement the operations of the above-described method implementations, for example, perform the methods as shown in FIGS. 5 to 8.

An implementation of the present disclosure provides a computer device including a processor and a readable storage medium coupled to the processor. The readable storage medium stores executable instructions, which, when executed by the processor, can implement the operations of the above-described method implementations, for example, perform the methods as shown in FIGS. 5 to 8.

Implementations of the present disclosure provide a method of adjusting a priority of a submission queue, a host, an electronic device, and a computer device, wherein the priority of the submission queues is adjusted by using latency scores of the submission queues, which are calculated by using latency periods of the submission queues, and an instruction is sent to give notification of a result of priority adjustment of a target submission queue. Since the latency period of a submission queue can reflect the time needed to complete execution of a single command in the submission queue to some extent, priorities of submission queues are adjusted according to latency scores of submission queues which are calculated by using latency periods of the submission queues, so that the risk that commands aren't executed for a longer time due to improper assignment of commands by the host can be reduced.

Implementations of the present disclosure provide a method for adjusting a priority of a submission queue, a host, an electronic device, and a computer device. They are used to reduce a risk that commands aren't executed for a longer time.

For achieving the purpose above, implementations of the present disclosure employ the following technical solutions.

In a first aspect, a method for adjusting a priority of a submission queue is provided. The method includes: acquiring latency periods of a plurality of submission queues, wherein the latency periods of the submission queues are determined by an average value of completion periods of a plurality of commands in the submission queues, and the completion period is a difference between a timing at which an execution of a command is completed and a timing at which the command is added to the submission queue; determining latency scores of the submission queues based on the latency periods of the submission queues; determining a target submission queue among the plurality of submission queues based on the latency scores of the submission queues and adjusting the priority of the target submission queue; and sending an instruction to give notification of a result of a priority adjustment of the target submission queue.

In a method for adjusting a priority of a submission queue as provided by the present disclosure, latency scores of a plurality of submission queues are calculated by latency periods of the submission queues, and then a target submission queue that needs priority adjustment is determined among the plurality of submission queues according to the latency scores of the submission queues. A latency period of a submission queue can reflect time needed to complete an execution of a single command in the submission queue to some extent, and the longer the latency period of the submission queue is, the longer the time, for which the commands in the submission queue wait to be executed, is. Therefore, by calculating latency scores of the submission queues through latency periods of the submission queues, the urgency of each submission queue of a plurality of submission queues can be estimated and in turn priorities of the submission queues can be adjusted. Then, an instruction can be sent to give notification of the result of priority adjustment of the target submission queue. As such, the risk that commands aren't executed for a longer time due to improper assignment of commands by the host can be reduced.

In some implementations, priorities of the submission queues include an urgent class and a weighted round robin arbitration (WWR) class with the urgent class being higher than the WWR class, and determining the target submission queue among the plurality of submission queues based on the latency scores of the submission queues and adjusting the priority of the target submission queue includes: among the plurality of submission queues, determining a submission queue with the highest latency score as a first target submission queue and adjusting the priority of the first target submission queue to be the urgent class; and/or among the plurality of submission queues, determining a submission queue with the lowest latency score as a second target submission queue and adjusting the priority of the second target submission queue to be the WWR class. The higher a latency score of a submission queue is, the longer the time, for which the commands in the submission queue wait to be executed, is, i.e. the higher the risk that the commands in the submission queue aren't executed for a longer time is. Therefore, by adjusting the priority of the first target submission queue with the highest latency score to be the urgent class, the commands in the first target submission queue can be processed with priority; and the priority of the second target submission queue with the lowest latency score is adjusted to be the WWR class, so as to avoid the round robin of a plurality of submission queues having the urgent class, which results in that the commands in the first target submission queue aren't executed in time. Accordingly, the risk that commands aren't executed for a longer time may be reduced.

In some implementations, determining the target submission queue among the plurality of submission queues based on the latency scores of the submission queues and adjusting the priority of the target submission queue includes: determining priority scores of the submission queues based on the latency scores of the submission queues and a number of commands in the submission queues; and determining the target submission queue among the plurality of submission queues based on the priority scores of the submission queues and adjusting the priority of the target submission queue. For a submission queue having a relatively larger number of commands, the commands at relatively rear location in the submission queue may also have the risk of remaining unexecuted for a longer time. Therefore, priority scores of submission queues are determined from the number of commands in the submission queues and the latency scores of the submission queues and a target submission queue is determined by the priority scores of the submission queues, so that the risk that the commands at relatively rear location aren't executed for a longer time may be reduced.

In some implementations, priorities of the submission queues include an urgent class and a weighted round robin arbitration (WWR) class with the urgent class being higher than the WWR class, and determining the target submission queue among the plurality of submission queues based on the priority scores of the submission queues and adjusting the priority of the target submission queue includes: among the plurality of submission queues, determining a submission queue with the highest priority score as a first target submission queue and adjusting the priority of the first target submission queue to be the urgent class; and/or among the plurality of submission queues, determining a submission queue with the lowest priority score as a second target submission queue and adjusting the priority of the second target submission queue to be the WWR class. In the present disclosure, the larger the number of commands in a submission queue is and the higher the latency score of the submission queue is, the higher the priority score of the submission queue is. Therefore, the priority of the first target submission queue with the highest priority score is adjusted to be the urgent class so as to process the commands in the first target submission queue with priority; and the priority of the second target submission queue with the lowest priority score is adjusted to be the WWR class, so as to avoid the round robin of a plurality of submission queues having the urgent class, which results in that the commands in the first target submission queue aren't executed in time. Accordingly, the risk that the commands at relatively rear location aren't executed for a longer time may be reduced.

In some implementations, the method further includes: determining the target submission queue among the plurality of submission queues based on the priority scores and latency scores of the submission queues and adjusting the priority of the target submission queue. A priority of a submission queue can be adjusted by using the priority score of the submission queue and the latency score of the submission queue in combination, so that the priority adjustment can be more accurate to some extent.

In some implementations, priorities of the submission queues include an urgent class and a weighted round robin arbitration (WWR) class with the urgent class being higher than the WWR class, and determining the target submission queue among the plurality of submission queues based on the priority scores and latency scores of the submission queues and adjusting the priority of the target submission queue includes: among the submission queues with the latency scores higher than a first threshold, determining a submission queue with the highest priority score as a first target submission queue and adjusting the priority of the first target submission queue to be the urgent class; and/or among the submission queues with the latency scores lower than a second threshold, determining a submission queue with the lowest priority score as a second target submission queue and adjusting the priority of the second target submission queue to be the WWR class, the second threshold being lower than the first threshold. The situation that a priority score of a submission queue is relatively higher due to a larger number of commands therein so that the priority adjustment is incorrect can be avoided to some extent.

In some implementations, the priority score of the submission queue is determined by a product of the latency score of the submission queue and the number of commands in the submission queue.

In some implementations, determining the latency scores of the submission queues based on the latency periods of the submission queues includes: calculating an average value μ of the latency periods of the plurality of submission queues; calculating a standard deviation σ of the latency periods of the plurality of submission queues; and determining the latency scores of the submission queues according to a mean normalization equation

$${score}_{i} = \frac{{lat}_{i} - μ}{σ} ,$$

wherein latᵢ is the latency period of an ith submission queue, and scoreᵢ is the latency score of the ith submission queue. In this way, the characteristic values are normalized into the same dimension to eliminate the problem of weight imbalance.

In a second aspect, a host is provided, which includes a host processor and an interface circuit for coupling with a memory system. The host processor is configured to: acquire latency periods of a plurality of submission queues, wherein the latency periods of the submission queues are determined by an average value of completion periods of a plurality of commands in the submission queues, and the completion period is a difference between a timing at which an execution of a command is completed and a timing at which the command is added to the submission queue; determine latency scores of the submission queues based on the latency periods of the submission queues; and determine a target submission queue among the plurality of submission queues based on the latency scores of the submission queues and adjust the priority of the target submission queue, and the interface circuit is configured to send an instruction to give notification of a result of a priority adjustment of the target submission queue.

In some implementations, priorities of the submission queues include an urgent class and a weighted round robin arbitration (WWR) class with the urgent class being higher than the WWR class, and the host processor determining the target submission queue among the plurality of submission queues based on the latency scores of the submission queues and adjusting the priority of the target submission queue is configured to: among the plurality of submission queues, determine a submission queue with the highest latency score as a first target submission queue and adjust the priority of the first target submission queue to be the urgent class; and/or among the plurality of submission queues, determine a submission queue with the lowest latency score as a second target submission queue and adjust the priority of the second target submission queue to be the WWR class.

In some implementations, the host processor determining the target submission queue among the plurality of submission queues based on the latency scores of the submission queues and adjusting the priority of the target submission queue is configured to: determine priority scores of the submission queues based on the latency scores of the submission queues and a number of commands in the submission queues; and determine the target submission queue among the plurality of submission queues based on the priority scores of the submission queues and adjust the priority of the target submission queue.

In some implementations, priorities of the submission queues include an urgent class and a weighted round robin arbitration (WWR) class with the urgent class being higher than the WWR class, and the host processor determining the target submission queue among the plurality of submission queues based on the priority scores of the submission queues and adjusting the priority of the target submission queue is configured to: among the plurality of submission queues, determine a submission queue with the highest priority score as a first target submission queue and adjust the priority of the first target submission queue to be the urgent class; and/or among the plurality of submission queues, determine a submission queue with the lowest priority score as a second target submission queue and adjust the priority of the second target submission queue to be the WWR class.

In some implementations, the host processor is also configured to determine the target submission queue among the plurality of submission queues based on the priority scores and latency scores of the submission queues and adjust the priority of the target submission queue.

In some implementations, priorities of the submission queues include an urgent class and a weighted round robin arbitration (WWR) class with the urgent class being higher than the WWR class, and the host processor determining the target submission queue among the plurality of submission queues based on the priority scores and latency scores of the submission queues and adjusting the priority of the target submission queue is configured to: among the submission queues with the latency scores higher than a first threshold, determine a submission queue with the highest priority score as a first target submission queue and adjust the priority of the first target submission queue to be the urgent class; and/or among the submission queues with the latency scores lower than a second threshold that is lower than the first threshold, determine a submission queue with the lowest priority score as a second target submission queue and adjust the priority of the second target submission queue to be the WWR class.

In some implementations, the priority score of the submission queue is determined by a product of the latency score of the submission queue and the number of commands in the submission queue.

In some implementations, the host processor determining the latency scores of the submission queues based on the latency periods of the submission queues is configured to: calculate an average value μ of the latency periods of the plurality of submission queues; calculate a standard deviation σ of the latency periods of the plurality of submission queues; and determine the latency scores of the submission queues according to a mean normalization equation

$${score}_{i} = \frac{{lat}_{i} - μ}{σ} ,$$

wherein latᵢ is the latency period of an ith submission queue, and scoreᵢ is the latency score of the ith submission queue.

In a third aspect, an electronic device is provided, which includes a host including a first interface and a memory system including a second interface. The host and the memory system are coupled with each other through the first interface and the second interface. The first interface is configured to send a first instruction to give notification of a result of priority adjustment of a target submission queue among a plurality of submission queues; and the second interface is configured to receive the first instruction and send a second instruction to the host based on the received first instruction.

In a fourth aspect, a computer device is provided, which includes a processor and a readable storage medium coupled with the processor. The readable storage medium stores executable instructions, which, when executed by the processor, can implement any one of the methods in the first aspect described above.

In the fifth aspect, a computer readable storage medium is provided, which stores computer executable instructions. The computer executable instructions when executed can implement any one of the methods in the first aspect described above.

It can be appreciated by those skilled in the art that, for convenience and simplicity of description, the implementations above have been described with their respective emphases and some contents that have not been detailed in one implementation may be found in the corresponding processes of the foregoing method implementations and will not be repeated here.

It can be understood that, in various implementations of the present disclosure, the ordinal numbers as used in the various processes above are not intended to indicate that the processes must be performed in any sequential order, and the various processes should be performed in a sequential order determined depending on their functions and inherent logic. Accordingly, Implementation of processes in the present disclosure is not limited in this respect.

It can be appreciated by those skilled in the art that various example modules and algorithm operations described in connection with the implementations disclosed herein can be implemented in an electronic hardware or a combination of a computer software and an electronic hardware. Whether to implement those functions in hardware or software depends on the specific application and design constraints of the technical solutions. Those skilled in the art may use a different method to achieve the functions for each particular application without departing from the scope of the disclosure.

What has been described is only specific implementations of the present disclosure and the scope claimed by the present disclosure is not limited thereto. Variations or substitutions that easily occur to those skilled in the art based upon the present disclosure should be covered by the scope claimed by the present disclosure. Therefore, the scope of the present disclosure should be determined by the scope of the claims.

What is claimed is:

1. A method of adjusting a priority of a submission queue, comprising:
acquiring latency periods of a plurality of submission queues, wherein the latency period of each of the submission queues is determined by an average value of a sum of completion periods of a plurality of commands in each of the submission queues, and the completion period is a difference between a timing at which an execution of the command is completed and a timing at which the command is added to the submission queue;
determining latency scores of the submission queues based on the latency periods of the submission queues;
determining a target submission queue among the plurality of submission queues based on the latency scores of the submission queues and adjusting the priority of the target submission queue; and
sending an instruction to give notification of a result of a priority adjustment of the target submission queue.

2. The method of claim 1, wherein priorities of the submission queues comprise an urgent class and a weighted round robin arbitration (WWR) class with the urgent class being higher than the WWR class, and
determining the target submission queue among the plurality of submission queues based on the latency scores of the submission queues and adjusting the priority of the target submission queue comprises:
among the plurality of submission queues, determining the submission queue with the highest latency score as a first target submission queue and adjusting the priority of the first target submission queue to be the urgent class; and/or
among the plurality of submission queues, determining the submission queue with the lowest latency score as a second target submission queue and adjusting the priority of the second target submission queue to be the WWR class.

3. The method of claim 1, wherein determining the target submission queue among the plurality of submission queues based on the latency scores of the submission queues and adjusting the priority of the target submission queue comprises:
determining priority scores of the submission queues based on the latency scores of the submission queues and a number of commands in the submission queues; and
determining the target submission queue among the plurality of submission queues based on the priority scores of the submission queues and adjusting the priority of the target submission queue.

4. The method of claim 3, wherein priorities of the submission queues comprise an urgent class and a weighted round robin arbitration (WWR) class with the urgent class being higher than the WWR class, and
determining the target submission queue among the plurality of submission queues based on the priority scores of the submission queues and adjusting the priority of the target submission queue comprises:
among the plurality of submission queues, determining the submission queue with the highest priority score as a first target submission queue and adjusting the priority of the first target submission queue to be the urgent class; and/or
among the plurality of submission queues, determining the submission queue with the lowest priority score as a second target submission queue and adjusting the priority of the second target submission queue to be the WWR class.

5. The method of claim 3, further comprising:
determining the target submission queue among the plurality of submission queues based on the priority scores and latency scores of the submission queues and adjusting the priority of the target submission queue.

6. The method of claim 5, wherein priorities of the submission queues comprise an urgent class and a weighted round robin arbitration (WWR) class with the urgent class being higher than the WWR class, and
determining the target submission queue among the plurality of submission queues based on the priority scores and latency scores of the submission queues and adjusting the priority of the target submission queue comprises:
among the submission queues with the latency scores higher than a first threshold, determining the submission queue with the highest priority score as a first target submission queue and adjusting the priority of the first target submission queue to be the urgent class; and/or
among the submission queues with the latency scores lower than a second threshold, determining the submission queue with the lowest priority score as a second target submission queue and adjusting the priority of the second target submission queue to be the WWR class, and
wherein the second threshold is lower than the first threshold.

7. The method of claim 3, wherein the priority score of the submission queue is determined by a product of the latency score of the submission queue and the number of commands in the submission queue.

8. The method of claim 1, wherein determining the latency scores of the submission queues based on the latency periods of the submission queues comprises:
calculating an average value μ of the latency periods of the plurality of submission queues;
calculating a standard deviation σ of the latency periods of the plurality of submission queues; and
determining the latency scores of the submission queues according to a mean normalization equation
$${score}_{i} = \frac{{lat}_{i} - μ}{σ} ,$$
wherein i is a number of the submission queues, latᵢ is the latency period of an ith submission queue, and scoreᵢ is the latency score of the ith submission queue.

9. A host comprising a host processor and an interface circuit for coupling with a memory system, wherein the host processor is configured to:
acquire latency periods of a plurality of submission queues, wherein the latency periods of the submission queues are determined by an average value of a sum of completion periods of a plurality of commands in the submission queues, and the completion period is a difference between a timing at which an execution of the command is completed and a timing at which the command is added to the submission queue;
determine latency scores of the submission queues based on the latency periods of the submission queues; and
determine a target submission queue among the plurality of submission queues based on the latency scores of the submission queues and adjust a priority of the target submission queue, and
the interface circuit is configured to:
send an instruction to give notification of a result of a priority adjustment of the target submission queue.

10. The host of claim 9, wherein priorities of the submission queues comprise an urgent class and a weighted round robin arbitration (WWR) class with the urgent class being higher than the WWR class, and
the host processor determining the target submission queue among the plurality of submission queues based on the latency scores of the submission queues and adjusting the priority of the target submission queue is configured to:
among the plurality of submission queues, determine the submission queue with the highest latency score as a first target submission queue and adjust the priority of the first target submission queue to be the urgent class; and/or
among the plurality of submission queues, determine the submission queue with the lowest latency score as a second target submission queue and adjust the priority of the second target submission queue to be the WWR class.

11. The host of claim 9, wherein the host processor determining the target submission queue among the plurality of submission queues based on the latency scores of the submission queues and adjusting the priority of the target submission queue is configured to:
determine priority scores of the submission queues based on the latency scores of the submission queues and a number of commands in the submission queues; and
determine the target submission queue among the plurality of submission queues based on the priority scores of the submission queues and adjust the priority of the target submission queue.

12. The host of claim 11, wherein priorities of the submission queues comprise an urgent class and a weighted round robin arbitration (WWR) class with the urgent class being higher than the WWR class, and
the host processor determining the target submission queue among the plurality of submission queues based on the priority scores of the submission queues and adjusting the priority of the target submission queue is configured to:
among the plurality of submission queues, determine the submission queue with the highest priority score as a first target submission queue and adjust the priority of the first target submission queue to be the urgent class; and/or
among the plurality of submission queues, determine the submission queue with the lowest priority score as a second target submission queue and adjust the priority of the second target submission queue to be the WWR class.

13. The host of claim 9, wherein the host processor is further configured to:
determine the target submission queue among the plurality of submission queues based on the priority scores and latency scores of the submission queues and adjust the priority of the target submission queue.

14. The host of claim 13, wherein priorities of the submission queues comprise an urgent class and a weighted round robin arbitration (WWR) class with the urgent class being higher than the WWR class, and
the host processor determining the target submission queue among the plurality of submission queues based on the priority scores and latency scores of the submission queues and adjusting the priority of the target submission queue is configured to:
among the submission queues with the latency scores higher than a first threshold, determine the submission queue with the highest priority score as a first target submission queue and adjust the priority of the first target submission queue to be the urgent class; and/or
among the submission queues with the latency scores lower than a second threshold lower than the first threshold, determine the submission queue with the lowest priority score as a second target submission queue and adjust the priority of the second target submission queue to be the WWR class.

15. The host of claim 9, wherein the priority score of the submission queue is determined by a product of the latency score of the submission queue and a number of commands in the submission queue.

16. The host of claim 9, wherein the host processor determining the latency scores of the submission queues based on the latency periods of the submission queues is configured to:
calculate an average value μ of the latency periods of the plurality of submission queues;
calculate a standard deviation σ of the latency periods of the plurality of submission queues; and
determine the latency scores of the submission queues according to a mean normalization equation
$${score}_{i} = \frac{{lat}_{i} - μ}{σ} ,$$
wherein i is a number of the submission queues, latᵢ is the latency period of an ith submission queue, and scoreᵢ is the latency score of the ith submission queue.

17. An electronic device comprising a host comprising a first interface and a memory system comprising a second interface, the host and the memory system being coupled with each other through the first interface and the second interface, wherein
the first interface is configured to send a first instruction to the memory system to give notification of a result of a priority adjustment of a target submission queue among a plurality of submission queues; and
the second interface is configured to receive the first instruction from the host and send a second instruction to the host to feedback a reception of the first instruction.

18. The electronic device of claim 17, wherein after the second interface sends a second instruction to the host to feedback the reception of the first instruction, the memory system executes commands from a plurality of submission queues through the second interface.

19. The electronic device of claim 18, wherein the memory system executes commands from the plurality of submission queues through the second interfaces based on at least one of the result of the priority adjustment and a weighted round robin arbitration.

20. The electronic device of claim 18, wherein after the memory system executes the commands, the second interface is configured to:
notify the host of a completion of the commands; and
notify the memory system that an execution result in a completion queue has been checked by the host.
